(19) United States
(12) Patent Application Publication
(10) Pub. No.: US 2003/0234544 A1
(43) Pub. Date: Dec. 25, 2003

(54) Emergency-locking latch assembly for a vehicle door

(75) Inventors: Krystof P. Jankowski, Waterford, MI (US); Igor Pereverzev, Farmington Hills, MI (US); Robert E. Tait, Redford, MI (US); Raymond E. Zeller, Westland, MI (US); Venkatesh Krishnan, Westland, MI (US); David Vern Cieglo, Bloomfield Hills, MI (US); James Joseph Loschiavo, Livonia, MI (US); Carsten C. Buettner, Koein (DE)

Correspondence Address: KEVIN G. MIERZWA, ARTZ & ARTZ, P.C., 28333 TELEGRAPH ROAD, SUITE 250, SOUTHFIELD, MI, 48034, US

(73) Assignees: Ford Motor Company, Dearborn, MI (US); Intier Automotive, Newmarket (CA)

(21) Appl. No.: 10/250,176

(22) Filed: Jun. 10, 2003

Related U.S. Application Data
(60) Provisional application No. 60/388,279, filed on Jun. 13, 2002.

(51) Int. Cl. E05C 3/16

(52) U.S. Cl. 292/220

(57) ABSTRACT

An emergency-locking latch assembly (14) is provided for securing a vehicle door (12) in a closed position. Specifically, in one embodiment, the emergency-locking latch assembly (14) is intended to secure a first door fastener (16) to an opposing second door fastener (18) when the vehicle door (12) is subjected to a substantial acceleration. In this embodiment, the emergency-locking latch assembly (14) includes a release lever (26) coupled to the first door fastener (16). This release lever (26) is intended to selectively disengage the first door fastener (16) from the opposing second door fastener (18) thereby releasing the vehicle door (12) from its closed position. The emergency-locking latch assembly (14) further includes an inertia-actuated detent lever (38) that is intended to block a predetermined path of the release lever (26) and prevent the release lever (26) from unlatching the vehicle door (12) from its closed position.

### CROSS REFERENCE TO RELATED APPLICATIONS

The present invention claims priority from U.S. Provisional Application Serial No. 60/388,279 filed on Jun. 13, 2002, and entitled “Lateral Inertia Latch”.

### BACKGROUND OF INVENTION

The present invention relates generally to vehicle doors, and more particularly to an emergency-locking latch assembly that secures a vehicle door in a closed position when the vehicle door is subjected to a substantial acceleration.

Vehicle doors are commonly equipped with latch assemblies for securing the vehicle doors in a closed position. These latch assemblies can also be utilized for selectively releasing the vehicle doors from the closed position and allowing those doors to be swung open.

A typical latch assembly includes one or more ratchets for engaging corresponding striking pins that extend from a door jam of the vehicle. Each ratchet usually is coupled to a series of intermediate release levers for causing the ratchet to disengage from the striking pin. These intermediate release levers ordinarily are coupled to and operated by one or more actuation mechanisms, e.g. inside and outside door handles.

A drawback of these latch assemblies is that they can inadvertently release the vehicle door from its closed position. For example, during a vehicle side impact, substantial sheet metal deformation can cause the outside door handle to flex thereby actuating the ratchet to disengage from the striking pin. Moreover, it is also understood that a variety of conditions can subject the vehicle to a substantial acceleration which could provide one of the intermediate levers with sufficient momentum to rotate or otherwise move the intermediate lever in a manner that unlatches the vehicle door from its closed position.

The inadvertent release of the vehicle door from its closed position clearly is disadvantageous because it can significantly compromise the safety of the occupants within the vehicle. For example, during a vehicle collision, the unlatched vehicle door may swing open and allow an unbelted occupant to be thrown from the vehicle. Alternatively, the occupant may remain in the vehicle but be injured by an object entering the vehicle that would have otherwise been blocked by the closed vehicle door. In addition to these two specific examples, it is that various other disadvantages can be associated with the inadvertent unlatching of the vehicle door.

Therefore, a need exists for an emergency-locking latch assembly that secures a vehicle door in a closed position when the vehicle is subjected to a vehicle collision or various other conditions that impart a substantial acceleration upon the vehicle door.

### SUMMARY OF INVENTION

The present invention provides an emergency-locking latch assembly that can be utilized for securing a vehicle door in a closed position. Specifically, in one embodiment, the emergency-locking latch assembly is intended to secure a first door fastener to an opposing second door fastener when the vehicle door is subjected to a substantial acceleration. In this embodiment, the emergency-locking latch assembly includes a release lever coupled to the first door fastener. This release lever is intended to selectively disengage the first door fastener from the opposing second door fastener thereby releasing the vehicle door from its closed position. The emergency-locking latch assembly further includes an inertia-actuated detent lever that is pivotally coupled to the vehicle door and is moveable between a release position and a detent position. In the release position, the inertia-actuated detent lever is offset from the release lever to allow the release lever to move along a predetermined path and unlatch the vehicle door from its closed position. On the other hand, in the detent position, the inertia-actuated detent lever is aligned with the release lever in order to block the predetermined path of the release lever and prevent the release lever from unlatching the vehicle door from its closed position.

One advantage of the present invention is that an inertia actuated detent lever is provided that is regularly displaced in order to prevent the detent lever from inadvertently becoming fixed in one position or otherwise becoming inoperable.

Another advantage of the present invention is that an emergency-locking latch assembly is provided that can secure a vehicle door in a closed position thereby preventing an object from entering the vehicle and injuring an occupant within the vehicle in the event of a collision.

Yet another advantage of the present invention is that an emergency-locking latch assembly is provided that can secure a vehicle door in a closed position for the purpose of preventing an unbelted occupant within the vehicle from being thrown therefrom and becoming seriously injured.

Still another advantage of the present invention is that an emergency-locking latch assembly is provided that permits a vehicle door to be readily opened under safe conditions when the vehicle is not subjected to a vehicle collision or various other conditions involving a substantial amount of acceleration.

Other advantages of the present invention will become apparent upon considering the following detailed description and appended claims, and upon reference to the accompanying drawings.

### BRIEF DESCRIPTION OF DRAWINGS

For a more complete understanding of this invention, reference should now be made to the embodiments illustrated in greater detail in the accompanying drawings and described below by way of the examples of the invention:

FIG. 1 is a perspective view of a vehicle with a vehicle door in an open position and having an emergency-locking latch assembly integrated therein, according to one embodiment of the present invention.

FIG. 2 is a rear perspective view of an emergency-locking latch assembly, according to one embodiment of the present invention.

FIG. 3 is a front plan view of the emergency-locking latch assembly shown in FIG. 2.

FIG. 4A is a plan view of a release lever and an inertia-actuated detent lever of the emergency-locking latch assembly, illustrating the release lever in a latched position and the inertia-actuated detent lever in a release position, according to one embodiment of the present invention.

FIG. 4B is a plan view of a release lever and an inertia-actuated detent lever of the emergency-locking latch assembly, illustrating the release lever in an unlatched position and the inertia-actuated detent lever in a release position, according to one embodiment of the present invention.

FIG. 4C is a plan view of a release lever and an inertia-actuated detent lever of the emergency-locking latch assembly, illustrating the release lever in a latched position and the inertia-actuated detent lever in a detent position, according to one embodiment of the present invention.

FIG. 5 is an exploded view of an inertia-actuated detent lever, according to one embodiment of the present invention.

FIG. 6 is a perspective view of a release lever and an inertia-actuated detent lever of the emergency-locking latch assembly, according to another embodiment of the present invention.

FIG. 7A is a plan view of a release lever and an inertia-actuated detent lever of the emergency-locking latch assembly, illustrating the release lever in a latched position and the inertia-actuated detent lever in a detent position, according to another embodiment of the present invention.

FIG. 7B is a plan view of a release lever and an inertia-actuated detent lever of the emergency-locking latch assembly, illustrating the release lever in an unlatched position and the inertia-actuated detent lever in a release position, according to another embodiment of the present invention.

FIG. 7C is a plan view of a release lever and an inertia-actuated detent lever of the emergency-locking latch assembly, illustrating the release lever in a latched position and the inertia-actuated detent lever in a detent position, according to another embodiment of the present invention.

FIG. 8 is a perspective view of a release lever and an inertia-actuated detent lever of the emergency-locking latch assembly, according to yet another embodiment of the present invention.

FIG. 9A is a plan view of a release lever and an inertia-actuated detent lever of the emergency-locking latch assembly, illustrating the release lever in a latched position and the inertia-actuated detent lever in a detent position.

FIG. 9B is a plan view of a release lever and an inertia-actuated detent lever of the emergency-locking latch assembly, illustrating the release lever in an unlatched position and the inertia-actuated detent lever in a release position and.

FIG. 9C is a plan view of a release lever and an inertia-actuated detent lever of the emergency-locking latch assembly, illustrating the release lever in a latched position and the inertia-actuated detent lever in a detent position.

### DETAILED DESCRIPTION

In the following figures, the same reference numerals are used to identify the same components in the various views.

The present invention is particularly suited for integration within a vehicle door for the purpose of securing the vehicle door in a closed position when the vehicle door is subjected to a vehicle collision or otherwise subjected to a substantial acceleration. In this regard, the embodiments described herein employ features where the context permits. However, it is understood that a variety of other embodiments without the described features are contemplated as well. For this reason, it follows that the present invention can be carried out in various other modes and utilized for other suitable applications as desired.

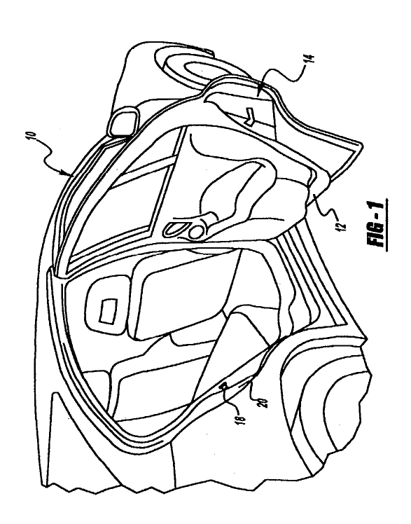

Referring to FIG. 1, there generally is shown a vehicle 10 having a vehicle door 12.with an emergency-locking latch assembly 14 (hereinafter referred to as “latch assembly”) integrated therein, in accordance with one embodiment of the present invention. This latch assembly 14 is intended to secure a vehicle door 12 in its closed position when the vehicle door 12 is subjected to a vehicle collision or otherwise subjected to a lateral inertia pulse, e.g. one greater than 20 Gs. Obviously, other magnitudes of forces may be the measuring point. The latch assembly 14 includes a ratchet 16 for engaging a striking pin 18 that extends from a door jam 20 of the vehicle 10. However, it should be noted that the latch assembly 14 can be integrated within the door jam 20 of the vehicle 10 instead of the vehicle door 12. In addition, it is also contemplated that the latch assembly 14 can utilize a variety of other suitable door fasteners besides the ratchet and the striking pin.

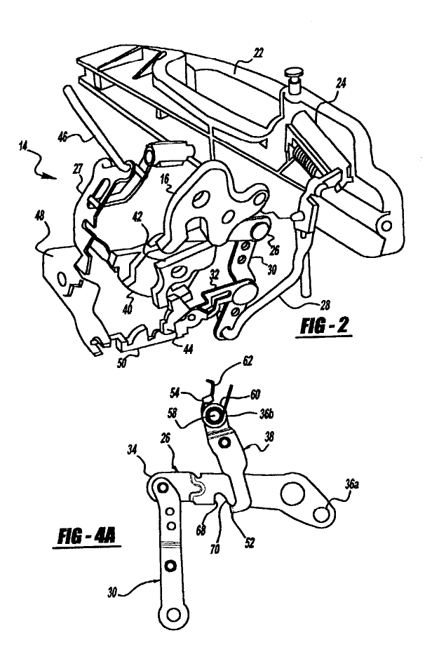

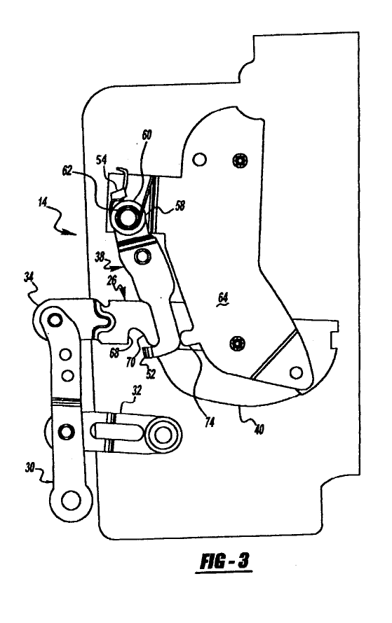

Referring now to FIGS. 2 and 3, there are shown views of the latch assembly 14 according to one embodiment of the invention. The latch assembly 14 includes an actuation mechanism for operating the latch assembly 14 and causing the ratchet 16 to selectively disengage the striking pin 18. As shown in FIG. 2, this actuation mechanism is an outside door handle 22 that can be pulled or otherwise manipulated by an individual for the purpose of transferring an applied force and operating the latch assembly 14. Incidentally, it will be appreciated that the actuation mechanism can instead be various other suitable devices, e.g. an inside door handle or a remotely controlled motor.

The outside door handle 22 is coupled to a counterbalance mechanism 24 (shown in FIG. 2). This counterbalance mechanism 24 is intended to bias the outside door handle 22 to a predetermined position, e.g. a retracted position, and also to translate an applied force from the outside door handle 22 to other portions of the latch assembly 14. To accomplish these purposes, the counterbalance mechanism 24 has a torsion spring (not shown) or other suitable biasing member coupled thereto. The torsion spring can apply a biasing force that is sufficiently high for locating the outside door handle 22 in the retracted position when the outside door handle 22 is not being manipulated by an individual. In addition, the biasing force is also sufficiently low for permitting an individual to pull the outside door handle 22 from its retracted position and overcome the biasing force of the torsion spring so as to cause the counterbalance mechanism 24 to rotate.

In this embodiment, the counterbalance mechanism 24 is operatively coupled to an outside release lever 26 by way of three intermediate levers. Namely, these intermediate levers are a connecting rod 28, an extension lever 30, and an auxiliary locating lever 32. These intermediate levers generally are intended to translate the applied force from the counterbalance mechanism 24 to the release lever 26. However, it is understood that more or less than three intermediate levers can be utilized as desired. For example, the latch assembly may omit all intermediate levers and directly couple the actuation mechanism to the outside release lever.

Specifically, with particular attention to FIG. 2, the counterbalance mechanism 24 is coupled to the connecting rod 28 for the purpose of forcing the connecting rod 28 downward as the counterbalance mechanism 24 is rotated by the outside door handle 22. Similarly, the connecting rod 28 is coupled to the extension lever 30 and is intended to force the extension lever 30 downward. As best shown in FIG. 3, this extension lever 30 is attached to a moveable end of the auxiliary locating lever 32. This auxiliary locating lever 32 has an opposite end pivotally attached to a mounting surface on the latch assembly 14. In this regard, the auxiliary locating lever 32 is intended to restrict the movement of the extension lever 30 within a generally vertical direction. The extension lever 30 is further coupled to a tip portion 34 of the outside release lever 26 in order to transfer the applied force thereto.

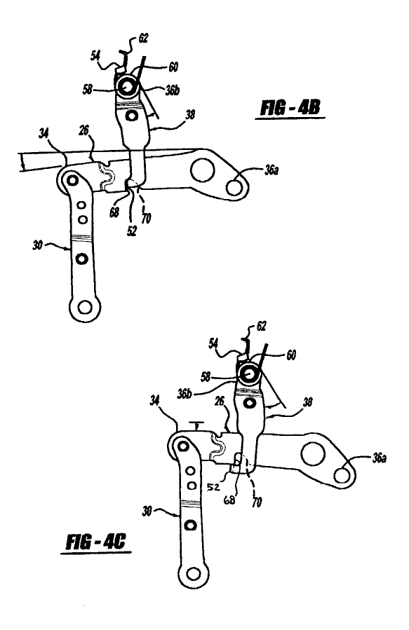

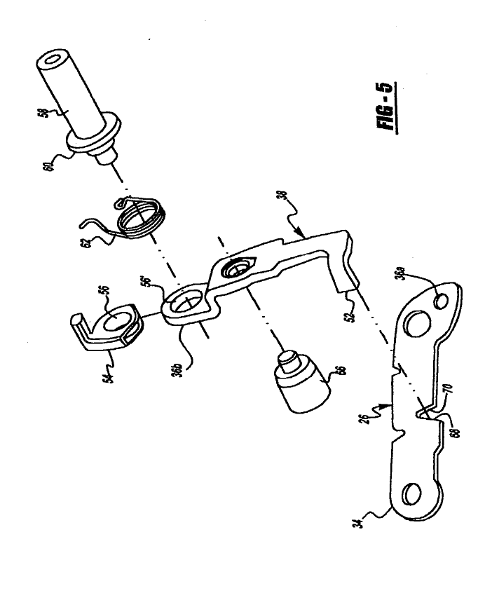

The outside release lever 26 further includes a pivoting end portion 36a that is pivotally coupled to a mounting surface of the latch assembly 14. The outside release lever 26 can pivot between a latched position (as shown in FIG. 4A) and an unlatched position (as shown in FIG. 4B). Furthermore, this outside release lever 26 has an inertia-actuated detent lever 38 (hereinafter referred to as “detent lever”) operatively coupled thereto for securing the outside release lever 26 in the latched position. This detent lever 38 is detailed in the description for FIGS. 4A-4C and 5.

In general, the movement of the outside release lever 26 between the latched position and the unlatched position allows the latch assembly 14 to disengage the ratchet 16 from the striking pin 18 and allows an individual to swing open the vehicle door 12.

The pivoting end portion 36a of the outside release lever 26 has a tab (not shown) extending laterally outward therefrom for contacting a triple hammer device 40 and causing the triple hammer device 40 to pivot about its rotation of axis. In this regard, pivoting the outside release lever 26 from the latched position to the unlatched position causes the triple hammer device 40 to likewise pivot. This triple hammer device 40 is operatively coupled to a pawl 42 via a locking link 44. The pawl 42 is intended to secure the ratchet 16 in a latched position. Rotating the triple hammer device 40 causes the pawl 42 to pivot and disengage from the ratchet 16. As a result, the ratchet 16 releases the striking pin 18 and allows the vehicle door 12 to be swung open.

From the foregoing, it will be seen that the latch assembly 14 can also include an inside door handle (not shown) coupled to an inside release lever 27 by way of a cable 46. This inside release lever 27 can be selectively coupled to the triple hammer device 40 to cause the triple hammer device 40 to disengage the pawl 42 from the ratchet 16 and release the striking pin 18 from the ratchet 16.

It is also contemplated that the latch assembly 14 can include an auxiliary inside lever 48 for disabling the latch assembly 14 and locking the vehicle door 12 in a latched position. As is known in the art, this auxiliary inside lever 48 is coupled to the locking link 44 by way of a lock element 50 or other suitable mechanism. In this respect, the auxiliary inside lever 48 can actuate the locking link 44 and detach the triple hammer device 40 from the pawl 42 thereby preventing the triple hammer device 40 from disengaging the pawl 42 from the ratchet 16. As a result, the operation of either door handle 22 would not cause the ratchet 16 to disengage the striking pin 18.

Referring now to FIGS. 4A and 4B, there are shown perspective views illustrating the outside release lever 26 in latched and unlatched positions, respectively, in accordance with one embodiment of the present invention. As hereinbefore set forth, the extension lever 30 can pull the tip portion 34 of the outside release lever 26 generally downward for the purpose of causing the outside release lever 26 to pivot about its pivoting end portion 36a and releasing the vehicle door 12 from its closed position.

This outside release lever 26 has the inertia-actuated detent lever 38 operatively coupled thereto for selectively locking the outside release lever 26 in the latched position. Specifically, this detent lever 38 has a detent tab 52 (as best shown in FIG. 5) extending therefrom for selectively engaging the outside release lever 26 and preventing the outside release lever 26 from pivoting along a predetermined path for unlatching the ratchet 16 from the striking pin 18. This detent lever 38 is moveable between a release position (as shown in FIGS. 4A and 4B) and a detent position (as shown in FIG. 4C). In the release position, the detent tab 52 is offset from the outside release lever in order to allow the outside release lever 26 to unlatch the ratchet 16 from the striking pin 18. In the detent position, the detent tab 52 blocks the path of the outside release lever 26 and locks the lever 26 in the latched position.

In one embodiment, as best shown in FIG. 5, the detent lever 38 has a pivoting end portion 36b that is sized for being covered by an encapsulation ring 54. The encapsulation ring 54 and the pivoting end portion 36b of the detent lever 38 each have an aperture 56, 56″ integrally formed therethrough for receiving a spindle member 58 and pivotally coupling the detent lever 38 to a mounting surface of the latch assembly 14, e.g. the back plate 64. The spindle member 58 includes an annular flange 60 for retaining the detent lever 38 against the back plate 64. The encapsulation ring 54 is comprised of a plastic material or other suitable corrosive-resistant material. In this regard, the encapsulation ring 54 is intended to prevent the corrosion of the mating surfaces between the annular flange 60 of the spindle member 58 and the pivoting end portion 36b of the detent lever 38. One skilled in the art would understand that the corrosion between those mating surfaces can fix the detent lever 38 in one position on the spindle member 58 thereby preventing the detent lever 38 from pivoting between the release position and the detent position. For that reason, the encapsulation ring 54 is beneficial for facilitating the free pivoting movement of the detent lever 38 on the spindle member 58 and thus allowing for the operation of the detent lever 38.

Moreover, the detent lever 38 has a torsion spring 62 coupled thereto for moving the detent lever 38 to its release position. However, instead of the torsion spring 62, it is contemplated that a variety of other suitable biasing members or even gravity can be utilized as desired.

Referring back to the embodiment shown in FIG. 3, the back plate 64 includes a lever guide member, e.g. a detent finger 74, extending therefrom for contacting the detent lever 38 and preventing the torsion spring 62 from moving the detent lever 38 in a counter-clockwise direction beyond its release position. However, it is contemplated that the lever guide member can have various other suitable constructions as desired. In addition, it is also understood that the lever guide member can be omitted from the latch assembly 14 provided that the resting position of the biasing member locates the detent lever 38 in its release position.

Referring back to FIG. 5, the detent lever 38 further includes a counterweight member 66 fixedly coupled thereto for allowing a substantial lateral acceleration of the detent lever 38, e.g. one caused by a side impact, to pivot the detent lever 38 from the release position to the detent position. In this regard, the acceleration of the detent lever 38 and its counterweight member 66 produces a resultant inertia force that is greater than the biasing force of the torsion spring 62. For that reason, the resultant inertia force moves the detent lever 38 to the detent position and prevents the outside release lever 26 from disengaging the ratchet 16 from the striking pin 18.

It is understood that the stiffness of the torsion spring 62, the mass of the counterweight member 66, and the location of the counterweight member 66 on the detent lever 38 can be adjusted according to the desired reaction characteristics of the detent lever 38. For example, a side impact under the action of a lateral inertia pulse above the 20 G level can cause the vehicle door to unlatch during the first 10 milliseconds after impact. Accordingly, the detent lever 38 can be tuned to engage the outside release lever 26 when the detent lever 38 is subjected to those particular conditions.

Additionally, it is understood that tuning the detent lever 38 and the outside release lever 26 can determine the amount of the angular and linear displacements of those lever 38, 26 required for engaging the detent lever 38 to the outside release lever 26. For instance, the detent lever 38 can be tuned such that the engagement between the detent lever 38 and the outside release lever 26 occurs under two conditions. The first condition can be that the detent lever 38 rotates by about 6.7 degrees thereby displacing the detent tab 52 by approximately 3.6 millimeters. Moreover, the second condition can be that the outside release lever 26 rotates about 3.6 degrees so as to displace the tip portion 34 of the outside release lever 26 by less than about 3.8 millimeters. However, it will be appreciated that various other angular and linear displacements of the outside release lever 26 and the detent lever 38 can be utilized for locking the latch assembly 14 in a latched position.

In the particular embodiment illustrated in FIGS. 4A-4C, the outside release lever 26 has a notch 68 integrally formed therein for receiving the detent tab 52 when the detent lever 38 is in the release position. In this regard, the notch 68 allows the outside release lever 26 to pivot about its pivoting end portion 36a thereby allowing the vehicle door 12 to be unlatched when the detent lever 38 is in the release position.

The outside release lever 26 further includes a sloped contact surface 70 disposed within the notch 68. This sloped contact surface 70 is intended to contact the detent tab 52 and pivot the detent lever 38 on the spindle member 58 when the outside release lever 26 is moved from its latched position to its unlatched position. This movement of the detent lever 38 can break dust sediment or corrosion build-up that can accumulate between the mating surfaces of the detent lever 38 and the spindle member 58. In this regard, the sloped contact surface 70 can prevent the detent lever 38 from becoming fixed in one position. This feature is beneficial because it will allow the detent lever to move between the release position and the detent position and lock the latch assembly 14 in the latched position.

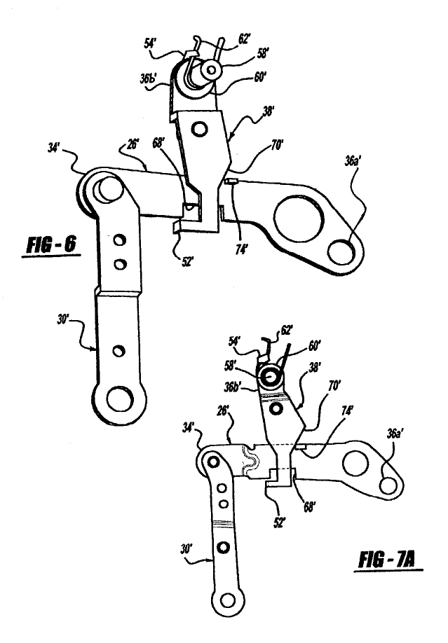

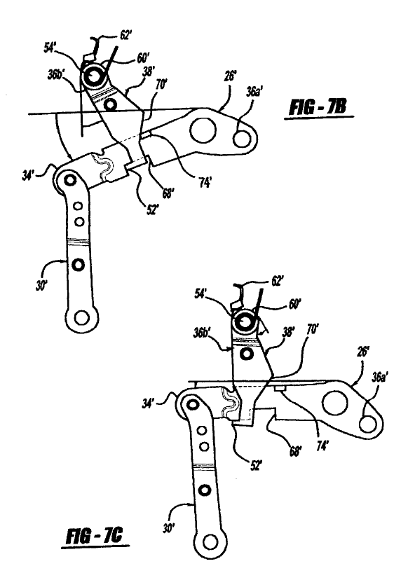

Referring now to FIG. 6, there is shown a perspective view of an outside release lever 26′ and a detent lever 38″ of a latch assembly 14′, according to another embodiment of the present invention. In greater detail, FIG. 7A shows this release lever 26′ in a latched position with the detent lever 38′ in a detent position. Furthermore, FIG. 7B illustrates the outside release lever 26′ moved to an unlatched position thereby simultaneously causing the detent lever 38′ to move to a release position. This relationship in movement between the outside release lever 26′ and the detent lever 38′ is detailed in the description for the lever guide member.

In the embodiment shown in these figures, the latch assembly 14′ includes a torsion spring 62′ coupled between the detent lever 38′ and a back plate 64′. This torsion spring 62′ is intended to move the detent lever 38′ in a predetermined direction. For example, as depicted in the FIGS. 7A and 7B, the torsion spring 62′ is employed for moving the detent lever 38′ in counter-clockwise direction from its detent position to its release position. It will be appreciated that various suitable biasing members other than the torsion spring can be utilized to move the detent lever in various suitable directions. Moreover, it is also contemplated that other suitable mounting surfaces in the latch assembly 14′ can be employed in place of the back plate 64′.

The latch assembly 14′ further includes a lever guide member, e.g. a detent finger 74′, extending from the outside release lever 26′ for contacting the detent lever 38′ and preventing the torsion spring 62′ from moving the detent lever 38′ beyond a predetermined position. Specifically, this detent finger 74′ extends laterally outward from the outside release lever 26′ (as best shown in FIG. 6) and is intended to contact a sloped contact surface 70′ of the detent lever 38′. For example, with reference to FIG. 7A, when the outside release lever 26′ remains in the latched position, the detent finger 74′ and the torsion spring 62 collectively position the detent lever 38′ in its detent position. However, turning now to FIG. 7B, as the outside release lever 26′ pivots from its latched position to its unlatched position, the detent finger 74′ slides across the sloped contact surface 70′ thereby allowing the torsion spring 62′ to move the detent lever 38′ to its release position.

In other words, the detent lever 38′ is routinely pivoted about the spindle member 58′ each time the outside release lever 26′ is moved between its latched position and its unlatched position. As mentioned above, this feature is beneficial because it can break up the accumulation of dust sediment or the corrosion of mating surfaces that can otherwise fix the detent lever 38′ in one position on the spindle member 58′. In that regard, the detent lever 38′ can freely move between a detent position and a release position. As a result, the detent lever 38′ and lock the latch assembly 14′ in a latched position when it is subjected to a substantial lateral acceleration yet also allow for normal operation of the latch assembly 14′.

In the particular embodiment illustrated in FIGS. 7A-7C, the detent lever 38′ has a detent tab 52′ extending therefrom for selectively engaging the outside release lever 26′ and preventing the outside release lever 26′ from moving from the latched position to the unlatched position. Upon inspection of FIG. 7C, it will be seen that a lateral inertia pulse, e.g. one greater than about 20 Gs, can cause the detent lever 38′ to remain in its detent position as the outside release lever 26′ begins moving toward its unlatched position thereby removing the detent finger 74′ from the sloped contact surface 70′. In this regard, the lateral inertia pulse can take the place of the detent finger 74′ by opposing the force of the torsion spring 62′ and holding the detent lever 38′ in the detent position. In this position, the detent tab 52′ will contact the outside release lever 26′ and lock the latch assembly 14′ in a latched position.

As exemplified in FIG. 7B, the outside release lever 26′ has a notch 68′ integrally formed therein for receiving the detent tab 52′ and allowing the outside release lever 26′ to move to its unlatched position. Specifically, when the detent lever 38′ is moved to its release position, the detent tab 52′ is aligned with the notch 68′ and therefore allows the notch 68′ to receive the detent tab 52′ therein. For that reason, this notch 68′ can allow the outside release lever 26′ to move to its unlatched position. However, it will be appreciated that the notch can be otherwise structured or even entirely omitted from the outside release lever. For example, in the release position, the detent tab can be completely offset from any portion of the outside release lever to prevent any possible contact between the detent tab and the detent lever. As a result, the outside release lever can freely move from the latched position to the unlatched position.

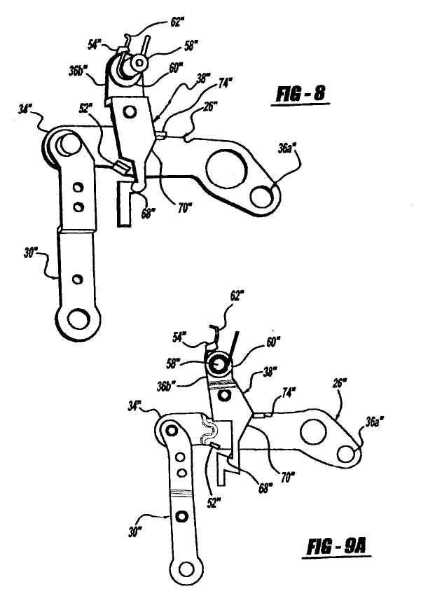

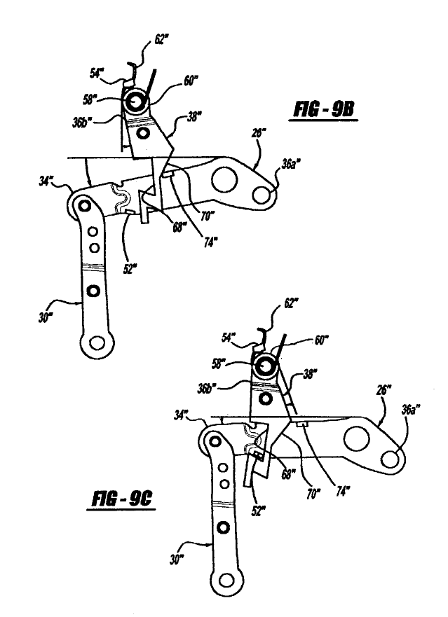

Referring now to FIG. 8, there is shown a perspective view of an outside release lever 26″ and a detent lever 38″ of a latch assembly 14″, according to yet another embodiment of the present invention. FIG. 9A illustrates this release lever 26″ in a latched position and the detent lever 38″ in a detent position. In addition, FIG. 9B illustrates the outside release lever 26″ moved to an unlatched position thereby simultaneously causing the detent lever 38″ to move to a release position. The overall construction allowing this movement between the outside release lever 26″ and the detent lever 38″ is detailed in the description for the lever guide member.

This embodiment requires that the latch assembly 14″ includes a torsion spring 62″ coupled between the detent lever 38″ and a back plate 64″. This torsion spring 62″ is intended to move the detent lever 38″ in a predetermined direction. By way of example, as shown in the FIGS. 9A and 9B, the torsion spring 62″ is utilized for moving the detent lever 38″ in a counter-clockwise direction from its detent position to its release position. It is understood that various other suitable biasing members besides the torsion spring can be utilized to move the detent lever in various suitable directions. Moreover, it will also be appreciated that other suitable mounting surfaces in the latch assembly 14″ can be utilized instead of the back plate 64″.

The latch assembly 14″ further includes a lever guide member, e.g. a detent finger 74″, extending from the outside release lever 26″ (as best illustrated in FIG. 8) for contacting the detent lever 38″ and preventing the torsion spring 62″ from moving the detent lever 38″ beyond a predetermined position. In particular, this detent finger 74″ extends laterally outward from the outside release lever 26″ and is intended to contact a sloped contact surface 70″ of the detent lever 38″. For instance, it will be apparent from FIG. 9A that when the outside release lever 26″ remains in the latched position, the detent finger 74″ and the torsion spring 62″ collectively position the detent lever 38″ in its detent position. Furthermore, turning to FIG. 9B, as the outside release lever 26″ pivots from its latched position to its unlatched position, the detent finger 74″ slides across the sloped contact surface 70″ thereby allowing the torsion spring 62″ to move the detent lever 38″ to its release position. This feature allows the detent lever 38″ to regularly pivot about the spindle member 58′ each time the outside release lever 26′ is moved between its latched position and its unlatched position. As hereinbefore stated, the advantage of this feature is that it can break up the accumulation of dust sediment or the corrosion of mating surfaces that can otherwise fix the detent lever 38′ in one position on the spindle member 58′. For that reason, the detent lever 38′ can freely move between a detent position and a release position. As a result, the detent lever 38′ and lock the latch assembly 14′ in a latched position when it is subjected to a substantial lateral acceleration yet also allow for normal operation of the latch assembly 14′.

In this embodiment, the outside release lever 26″ has a detent tab 52″ extending therefrom for selectively engaging the detent lever 38″ and preventing the outside release lever 26″ from moving from the latched position to the unlatched position. In particular, as shown in FIG. 9C, a lateral inertia pulse, e.g. one greater than about 20 Gs, can cause the detent lever 38″ to remain in its detent position as the outside release lever 26″ begins moving toward its unlatched position. It is understood that as the outside release lever 26″ pivots toward its unlatched position, the detent finger 74″ is removed from the sloped contact surface 70″. In this regard, the lateral inertia pulse takes the place of the detent finger 74″ by opposing the force of the torsion spring 62″ and holding the detent lever 38″ in the detent position. In this position, the detent tab 52″ contacts the detent lever 38″ and locks the latch assembly 14″ in a latched position.

Furthermore, according to this embodiment, the detent lever 341 has a notch 68″ integrally formed therein for receiving the detent tab 52″ and preventing the outside release lever 26″ to move to its unlatched position. Specifically, when the detent lever 38″ is moved to its detent position, the detent tab 52″ is aligned with the notch 68″. As a result, the notch 68″ can receive the detent tab 52″ therein and cause the detent lever 38″ to engage the detent tab 52″. In this way, the notch 68″ can prevent the outside release lever 26″ from moving to its unlatched position.

However, it will be appreciated that the notch can be otherwise structured or even entirely omitted from the outside release lever. For example, in the release position, the detent tab can be completely offset from any portion of the outside release lever and therefore allow the outside release lever to freely move from the latched position to the unlatched position.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

1. A detent mechanism of an emergency-locking latch assembly for a vehicle door, the detent mechanism intended to selectively block a predetermined path of a release mechanism and prevent the release mechanism from disengaging a first door fastener from an opposing second door fastener under certain circumstances, comprising:
a spindle member coupled to the vehicle door;
an inertia-actuated detent lever pivotally coupled to said spindle member, said inertia-actuated detent lever being moveable between at least one release position and a detent position; and
a sloped contact surface integrated on said inertia-actuated detent lever, said sloped contact surface for sliding a lever guide member thereacross and moving said inertia-actuated detent lever;
wherein said inertia-actuated detent lever in said at least one release position is offset from the release mechanism for allowing the release mechanism to move along the predetermined path for disengaging the first door fastener from the opposing second door fastener, said inertia-actuated detent lever in said detent position being aligned with the release mechanism and causing said detent tab to contact the release mechanism and block the predetermined path of the release mechanism.

2. The detent mechanism recited in claim 1 further comprising:
a biasing member coupled to said inertia-actuated detent lever and intended to apply a biasing force to said inertia-actuated detent lever for locating said inertia-actuated detent lever in said at least one release position during normal vehicle operation, said biasing force being less than a resultant inertia force derived from a substantial acceleration of said inertia-actuated detent lever.

3. The detent mechanism recited in claim 1 wherein said lever guide member is a detent finger extending from at least one of a back plate and a release mechanism.

4. The detent mechanism recited in claim 1 further comprising:
a counterweight coupled to said inertia-actuated detent lever and intended to cause said inertia-actuated detent lever to move to said detent position when said inertia-actuated detent lever is subjected to said substantial acceleration.

5. The detent mechanism recited in claim 1 further comprising:
an encapsulation ring coupled to a pivot end of said inertia-actuated detent lever, said encapsulation ring intended to facilitate movement between said pivot end of said inertia-actuated detent lever and said spindle member.

6. An emergency-locking latch assembly for securing a first door fastener to an opposing second door fastener in order to hold a vehicle door in a closed position under certain circumstances, comprising:
a release mechanism coupled to the first door fastener, said release mechanism intended to move along a predetermined path for selectively disengaging the first door fastener from the opposing second door fastener;
a spindle member coupled to the vehicle door; an inertia-actuated detent lever pivotally coupled to said spindle member, said inertia-actuated detent lever being moveable between at least one release position and a detent position; and
a sloped contact surface integrated on said release mechanism, said sloped contact surface for sliding said inertia-actuated detent lever thereacross and moving said inertia-actuated detent lever;
wherein said detent lever is selectively disposed in said detent position for blocking said predetermined path of said release mechanism and preventing said release mechanism from disengaging the first door fastener from the opposing second door fastener when said inertia-actuated detent lever is subjected to a substantial acceleration.

7. The emergency-locking latch assembly recited in claim 6 further comprising:
a biasing member coupled to said inertia-actuated detent lever and intended to apply a biasing force to said inertia-actuated detent lever for locating said inertia-actuated detent lever in said at least one release position during normal vehicle operation, said biasing force being less than a resultant inertia force derived from said substantial acceleration of said inertia-actuated detent lever.

8. The emergency-locking latch assembly recited in claim 6 wherein said release mechanism has a notch integrally formed therein for receiving said release mechanism when said inertia-actuated detent lever is located in said at least one release position.

9. The emergency-locking latch assembly recited in claim 6 further comprising:
an encapsulation ring coupled to a pivot end of said inertia-actuated detent lever, said encapsulation ring intended to facilitate movement between said pivot end of said inertia-actuated detent lever and said spindle member.

10. The emergency-locking latch assembly recited in claim 6 further comprising:
a lever guide member coupled to the emergency-locking latch assembly and intended to contact said inertia-actuated detent lever and prevent said inertia-actuated detent lever from moving beyond a predetermined position.

11. The emergency-locking latch assembly recited in claim 6 wherein said release mechanism is at least one of:
an outside release lever coupled between an outside release handle and the first door fastener; and
an inside release lever coupled between an inside release handle and the first door fastener.

12. The emergency-locking latch assembly recited in claim 6 wherein said inertia-actuated detent lever has a counterweight fixedly coupled thereto for moving said inertia-actuated detent lever to said detent position.

13. An emergency-locking latch assembly for securing a first door fastener to an opposing second door fastener in order to hold a vehicle door in a closed position, comprising:
a release mechanism coupled to the first door fastener, said release mechanism intended to move along a predetermined path for selectively disengaging the first door fastener from the opposing second door fastener;
a spindle member coupled to the vehicle door;
an inertia-actuated detent lever pivotally coupled to said spindle member, said inertia-actuated detent lever being moveable between at least one release position and a detent position; and
a detent tab extending from said release mechanism for contacting said inertia-actuated detent lever when said inertia-actuated detent lever is located in said detent position;
a sloped contact surface integrated on said inertia-actuated detent lever, said sloped contact surface for sliding a lever guide member thereacross and moving said inertia-actuated detent lever;
wherein said inertia-actuated detent lever is selectively disposed in said detent position for blocking said predetermined path of said release mechanism and preventing said release mechanism from disengaging the first door fastener from the opposing second door fastener when said inertia-actuated detent lever is subjected to a substantial acceleration.

14. The detent mechanism recited in claim 13 further comprising:
a biasing member coupled to said inertia-actuated detent lever and intended to apply a biasing force to said inertia-actuated detent lever for locating said inertia-actuated detent lever in said at least one release position during normal vehicle operation, said biasing force being less than a resultant inertia force derived from a substantial acceleration of said inertia-actuated detent lever.

15. The emergency-locking latch assembly recited in claim 13 wherein said inertia-actuated detent lever has a notch integrally formed therein for receiving said release mechanism when said inertia-actuated detent lever is located in said detent position.

16. The emergency-locking latch assembly recited in claim 13 further comprising:
an encapsulation ring coupled to a pivot end of said inertia-actuated detent lever, said encapsulation ring intended to facilitate movement between said pivot end of said inertia-actuated detent lever and said spindle member.

17. The emergency-locking latch assembly recited in claim 13 wherein said spindle member includes an annular flange for contacting said inertia-actuated detent lever and coupling said inertia-actuated detent lever to the vehicle door.

18. The emergency-locking latch assembly recited in claim 13 wherein said lever guide member is a detent finger extending from at least one of a back plate and a release mechanism.

19. The emergency-locking latch assembly recited in claim 13 wherein said release mechanism is at least one of:
an outside release lever coupled between an outside release handle and the first door fastener; and
an inside release lever coupled between an inside release handle and the first door fastener.

20. The emergency-locking latch assembly recited in claim 13 wherein said inertia-actuated detent lever has a counterweight fixedly coupled thereto for moving said inertia-actuated detent lever to said detent position.
